(19) United States
(12) Patent Application Publication
(10) Pub. No.: US 2012/0131330 A1
(43) Pub. Date: May 24, 2012

(54) System and Method for Processing Secure Transmissions

(75) Inventors: Johann Heinrich Tönsing, Zwartkop (ZA); Roelof Nico DuToit, Portersville, PA (US); Gysbert Floris van Beek Van Leeuwen, Erasmuckloof (ZA)

(73) Assignee: Netronome Systems, Inc., Santa Clara, CA (US)

(21) Appl. No.: 13/361,559

(22) Filed: Jan. 30, 2012

Related U.S. Application Data
(63) Continuation of application No. 12/064,560, filed on Aug. 18, 2008, now abandoned.

(30) Foreign Application Priority Data
Aug. 23, 2005 (GB) 0517303.4
Aug. 23, 2006 (IB) PCT/IB2006/052926

(51) Int. Cl. H04L 9/00

(52) U.S. Cl. 713/153

(57) ABSTRACT

Secured transmissions between a client and a server are detected, a policy formulated whether encrypted material needs to be decrypted, and if content is to be decrypted it is, using decrypting information obtained from the client and server. Resulting plain test is then deployed to an entity such as a processor, store or interface. The plain text can be checked or modified. The transmission between client and server could be blocked, delivered without being decrypted, decrypted and then re-encrypted with or without modification. Each transmission is given an ID and a policy tag.

### CROSS REFERENCE TO RELATED APPLICATION

This application is a continuation of, and claims priority under 35 U.S.C. §120 from, nonprovisional U.S. patent application Ser. No. 12/064,560 entitled “System and Method for Processing Secure Transmissions,” filed on Aug. 18, 2008, and published as U.S. Pat. Pub. No. 2009/0201978. Application Ser. No. 12/064,560 in turn is a continuation of, and claims priority under 35 U.S.C. §120 and §365(c) from International Application No. PCT/IB2006/052926, filed on Aug. 23, 2006, and published as WO 2007/023465 A3 on Mar. 1, 2007, which in turn claims priority from Great Britain Application No. 0517303.4, filed on Aug. 23, 2005, in the United Kingdom. The disclosure of each of the foregoing documents is incorporated herein by reference.

### BACKGROUND

This invention relates to a system and method for processing secure digital electronic transmissions.

### SUMMARY

According to the invention there is provided a system for processing a secure digital electronic transmission from a first device to a second device, which includes a determining means for determining whether the transmission needs to be decrypted; a decrypting information obtaining means for obtaining information required to decrypt the encrypted content, from the first or the second device or both, if decryption of the encrypted content is required; a decrypting means for decrypting the encrypted content of the transmission; and a deploying means for deploying at least a part of the decrypted content to an entity.

The system may include a transmission ID supplying and identifying means for supplying an ID for each transmission from the first device when it is initiated and for identifying the ID of a transmission subsequently. The determining means may provide a policy tag for each transmission that is associated with the ID of that transmission, the tag indicating whether or not any content is to be decrypted. The system may further include a re-encrypting means for re-encrypting material to be sent to the second device. The determining means may also determine if material associated with a transmission is to be re-encrypted and for supplying a policy tag which indicates that the material is to be re-encrypted.

Further, the system may includes a bypass means for routing at least a part of the original encrypted content of a transmission to the second device. The determining means may then also determine if the original encrypted content, or part thereof, should be supplied to the second device via the bypass means and supply a policy tag which indicates that that transmission may be bypassed.

It will be appreciated that, in use, the system will also receive unsecured traffic. The system may thus also have a detecting means for detecting a secure transmission, the determining means then determining if a secure transmission that has been detected is to be decrypted. Any unsecured transmissions may also be bypassed via the bypass means.

The determining means may determine if a transmission needs to be decrypted when the transmission is initiated. Alternatively, the determining means may determine if a transmission needs to be decrypted subsequent to initiation of the transmission. In addition, even if the determining means determines that a transmission should be decrypted, this determination could subsequently be changed to a determination that the transmission need not be decrypted and decryption is terminated. The determining means then also initially supplies a policy tag that indicates that decryption is required and later a modified tag that decryption is not required. The original encrypted content may then be supplied to the second device.

The entity to which the decrypted content is deployed may process, store or forward the content. An appropriate entity to which the decrypted content is deployed may be determined by the determining means and it may also select the entity to which the decrypted content should be deployed and supply a policy tag which indicates the identity of the selected entity. The re-encrypting means may re-encrypt material and forward it to the second device in response to a signal from the selected entity.

The deploying means may deploy the decrypted content to the selected entity in a read-only form or in a modifiable form. If the decrypted content is sent to the selected entity in a modifiable form, the selected entity may modify it and return it. The deploying means may then include a receiving means for receiving the modified content from the selected entity. The modified content received from the selected entity may then be re-encrypted by the re-encrypting means and forwarded to the second device. The system may, still further, include a transmission blocking means for blocking forwarding of at least a part of the transmission to the second device.

Further according to the invention there is provided a method of processing a secure digital electronic transmission from a first device to a second device, which includes determining whether the transmission needs to be decrypted; obtaining information required to decrypt the encrypted content, from the first or the second device or both, if decryption of the encrypted content is required; decrypting the encrypted content of the transmission; and deploying the decrypted content to an entity. The method may include supplying an ID for each transmission from the first device when it is initiated and for subsequently identifying the ID of a transmission. The method may also include providing a policy tag that is associated with the ID of each transmission, the tag indicating whether or not any content is to be decrypted. In addition, the method may include re-encrypting material to be sent to the second device. If re-encrypting is to be performed, an appropriate policy tag is supplied that indicates that the material is to be re-encrypted.

As indicated above, if the content need not be decrypted, at least a part of the original encrypted content of a transmission may be routed to the second device via a bypass route. Thus, the method may include determining if the original encrypted content, or part thereof, should be routed to the second device via the bypass route and supplying a policy tag which indicates that that transmission should be bypassed.

Determining whether a transmission needs to be decrypted may occur when the transmission is initiated or subsequent to initiation of the transmission. An initial determination may be made that encryption is required, which is subsequently changed to a determination that decryption is not required.

The decrypted content may be processed, stored or forwarded by the entity. The decrypted content may be deployed to a plurality of entities. A desired entity to which at least a part of the decrypted content should be deployed may be selected. A policy tag that indicates that at least a part of the decrypted content is to be deployed to the selected entity may then be supplied. The decrypted content may be deployed to the selected entity in a read-only or modifiable form. The re-encrypted version of the decrypted content may then be sent to the second device in response to a signal from the selected entity. If the selected entity modifies the material it receives, this modified material may be returned. This modified material may then be re-encrypted and sent to the second device. At least a part of the transmission may be blocked, and not sent to the second device. In order to cater for unsecured traffic, the method may include detecting that a transmission is a secured transmission.

From the above it will be appreciated that a secured transmission may be forwarded to the second device unmodified or modified, decrypted, unchanged but re-encrypted or in a modified and then re-encrypted form.

Further from the above, it will be appreciated that the entities may merely examine the decrypted material or process it. Thus, the decrypted material may be examined in order to detect any notable content, for example, illicit activity. The decrypted material may also be filtered to prevent intrusion. The decrypted material may further be packaged in a format suitable for a further application, depending on the application, such that to the application it appears as if the traffic was not encrypted prior to such packaging.

The entity may be a software module or program, an information processing device, a network node that forwards or processes information such as a router or server, or any combination thereof. As indicated above, the further entity may be passive in the sense that it does not modify the decrypted material or active, in which case it is able to modify the said material.

The decrypted material may be sent to the entity via an Application Program Interface (API) or as a stream, and the system may thus have a stream generator component. The provision of a stream generator component may thus allow standard, unmodified applications that have been designed to operate on plain non-encrypted text to operate on the decrypted material. The transmission may be in datagram or packet form.

The decrypting information obtaining means may have a key agreement component for providing the required information to decrypt and re-encrypt the transmission. This component procures the negotiated encryption algorithm(s), session key(s), and any random “obfuscator” or “seed” information.

In the event that the system determines that a transmission need not be decrypted, or in the event that the system determines that decryption is required but that no further entity needs to modify the decrypted information, the system may not terminate a connection in which the cryptographic session is embedded, such as a Transmission Control Protocol (TCP) connection in which SSL/TLS traffic is embedded.

In those instances where the system determines that the transmission has to be decrypted, the system may terminate the connection in which the cryptographic session is embedded, and the system may originate a new connection and transmission to the second device. The second device may not be aware that this “highjacking” has occurred. Thus, the address(es) or other connection identifiers, such as TCP ports, at each layer of the system may be set to the same address(es) and identifiers that the first and second devices used. In the event that the protocol being used does not permit substitution of addresses or other connection specific identifiers, then substitutions would not be made.

If the entity to which the decrypted material is to be deployed may only modify data and may not insert or remove data nor change the way in which the data is divided into datums or packets, then only the payload of the transmission may be modified by the system. In this mode, if a stream generator is used, the stream generator component may send data to the further entity and receive the data as modified by the entity. In this case, the further entity is most likely to be a physical entity, such as an appliance or an appliance running on a server, where multiple physical network or communication links can be attached to the entity or the platform on which the entity is hosted; a virtual entity, such as a virtual machine, running in the system or elsewhere, where the traffic can be made available to the entity or obtained after the entity has processed the traffic via Virtual Network Interface Cards (VNICs); or an application which has been designed or configured to interact with the stream generator by sending information it received back to the stream generator after processing the information.

The system may comprise a gateway that is part of a network. The gateway may be connected in the network in such a way that network traffic or other communications are forced to traverse the gateway. Thus, the gateway may be a router, a switch, or a “bump in the wire” bridge. Further, the gateway may comprise one or more processors or co-processors. If the gateway has a plurality of processors, they may be connected using a real trusted link, such as shared memory, a traditional server backplane bus such as PCI Express, or a network link such as Gigabit Ethernet; or are linked using a channel that is secure by virtue of it being encrypted.

The first device may be a client and the second device a server. The client may establish a secure communication session with the server using Secure Sockets Layer (SSL) or Transport Layer Security (TLS) protocols as a security layer. The transport layer may be TCP.

The determining means may use a variety of criteria in determining whether the transmission needs to be decrypted. These criteria may include: the port or interface of the system to which the client is attached; the port or interface to which the server is attached; source and destination addresses of the client and server; other source and destination intra-device or application identifiers; fields in a server public key certificate or client public key certificate; information with respect to negotiated encryption algorithms; and the content of the transmission. If the criterion used is a source or destination address, then the group to which it belongs may be considered. For example, it may be from a trusted or untrusted source, a public or private source, or an own or other organization.

Similarly, if fields in a public key certificate or information with respect to the encryption algorithms are considered, then they may be compared to constants or ranges, or may be matched against arbitrary patterns such as regular expressions. If transmission content is considered, then information such as an application protocol identifier or an identification of the initiating or target entity may be referred to. In regard to the latter, a username or resource being accessed may be relevant. Further, the information considered may be in a part of the transmission that is not encrypted or is encrypted. Examples of a protocol where an unencrypted part precedes an encrypted part are SMTP, POP3 or IMAP with the STARTTLS option, where the client issues the STARTTLS command to request commencement of TLS encryption.

It will be appreciated that the first and second devices could be nodes in a network that establish peer-to-peer communication sessions. Depending on the encryption protocol used, differences between the communicating parties may still exist. For example, one party may act as an initiator, with the other party being a target.

Components of the system could be implemented as tasks or modules in a real time operating system or a virtual machine hypervisor layer, as components in an operating system kernel, as user level libraries, components or applications, as software running directly on hardware, without an intervening operating system, or as hardware coprocessors implemented in fixed or reconfigurable devices. The system and method are also applicable to tunnels or other transmissions between devices that are not encrypted, such as traffic that is compressed, encoded, or encapsulated. In this case the benefit of the system remains that it is able to identify which transmissions are of interest and package or relay these transmissions in an appropriate form for examination or processing by a further entity.

It will further be appreciated that for each datum, such as a network packet or other piece of information, traversing the system, the system identifies the transmission to which the datum belongs. Thus, concurrent transmissions being transmitted across the same network or other communication channel or medium are separated. In addition, it will be appreciated that, after identifying a transmission, the system determines a policy to be associated with that transmission. The policy may encompass the following elements: whether the transmission is to be decrypted or whether it may pass through the system unchanged; to which destinations and via which mechanisms, protocols or encapsulations the decrypted information needs to be forwarded; and in which mode the system should operate for that transmission, e.g., allow only read-only access to the decrypted material or allow read-write access. If the policy associated with a transmission is known, the policy may merely be applied. If the policy has not been formulated then information in the datum may be analyzed to determine the required policy.

In the event that it is determined that no further entity needs to receive the decrypted material, that component of the system that communicates the decrypted material may be disabled or rendered idle. If supported by the encryption protocol, the system could enable triggering of a new session key negotiation process to remove the need to decrypt and re-encrypt the transmission. Further, in those cases where the original encrypted transmission is identical to the decrypted and re-encrypted transmission, the transmission may merely be forwarded once it has been determined that decryption is not required, or after decryption, but without re-encryption. This optimization will be possible if the negotiated encryption protocols, algorithms and parameters are compatible with this scheme. In the case of SSL/TLS, the same session key should be negotiated on the client to the system leg and the system to the server leg of the connection. This requires that the random data exchanged during the key agreement process be forwarded by each party to the other without modification and that the encryption algorithm should not use Cypher Block Chaining. An example of a suitable algorithm is a stream cipher such as RC4/ARCFOUR. The advertised algorithms could be changed during the session key agreement phase to ensure this.

If the transmission is modified by the system replacing the original certificate supplied by the first device or the second device with a certificate issued to the address/hostname of the server and signed by a certifying authority that is trusted by the first and second devices without the system modifying the latter certificate, then a warning or error message will probably result because the name in the certificate will not match the destination host name or IP address. Thus, resigning of certificates is preferred.

In order to cause a device to accept a resigned certificate without displaying warnings, the Certification Authority (CA) certificate belonging to the system needs to be installed into such device. The CA certificate may be installed by modifying streams by injecting HTML/XML tags or by distributing the CA certificate. Where the streams are modified by injecting HTML/XML tags or other information as appropriate to the protocol and content, the device is caused either to temporarily access information on the system or to access information on the system while concurrently loading the originally requested information, where the information supplied by the system has the side effect of installing a CA certificate. For example, it is a CA certificate itself, or causes an ActiveX, Java or other plugin to be invoked which, when executed, installs the CA certificate. Alternatively, the CA certificate is distributed via a remote automated software installation, remote desktop configuration, or other central management mechanism.

The stream generator component may make the decrypted material available as a stream to a further entity running on another processor, a further entity running on a processor forming part of the system, or a further entity attached to the same network as the system, or a combination thereof. The stream generator may supply a variety of stream types, including TCP, Sockets Direct Protocol (SDP), or the like. The stream generator may include the original packet or stream header information, such as TCP destination or source addresses or source or destination ports. Instead, the stream generator may modify this information in order to accommodate the requirements of an attached application. Stream content may likewise be modified, for example, by modifying stream content to reflect that data was not originally encrypted, or by adding stream content to reflect that data was encrypted or to communicate some of the original stream parameters, such as certificate fields, original addresses and ports, to the attached application. This will enable a further entity to gain access to decrypted material without requiring modifications to the hardware or software of the further entity.

It will be understood that the entity that will receive a stream, the required modifications to the stream, and other stream related parameters will be governed by the configured set of policies. As the policy to be followed is determined by transmission classification and identification components, different policies may be defined for various categories of transmissions, and the invention extends to the definition of such policies.

In regard to passive entities, the stream generator may ignore the payload of data packets or other datums supplied by such entities, while performing all processing required to ensure that communication of the stream is maintained, such as performing handshake steps to establish the stream and processes and send acknowledgments. In this case, the stream generator may detect and process a variety of stream related control messages or packets supplied by a passive further entity, such as ICMP port unreachable or TCP RESET messages. An appropriate action defined by the system configuration and the transmission handling policy is taken, for example, if the decrypted stream to the further entity cannot be established or is torn down, the system can tear down the encrypted streams to the first or second device.

Other embodiments and advantages are described in the detailed description below. This summary does not purport to define the invention. The invention is defined by the claims.

### BRIEF DESCRIPTION OF THE DRAWINGS

The invention is now described, by way of examples, with reference to the accompanying diagrammatic drawings which show schematically a system in accordance with the invention connected to clients, servers, and applications.

The invention is now described by way of example with reference to the accompanying diagrammatic drawing that schematically shows a system in accordance with the invention connected between a client and a server.

### DETAILED DESCRIPTION

Reference will now be made in detail to some embodiments of the invention, examples of which are illustrated in the accompanying drawing.

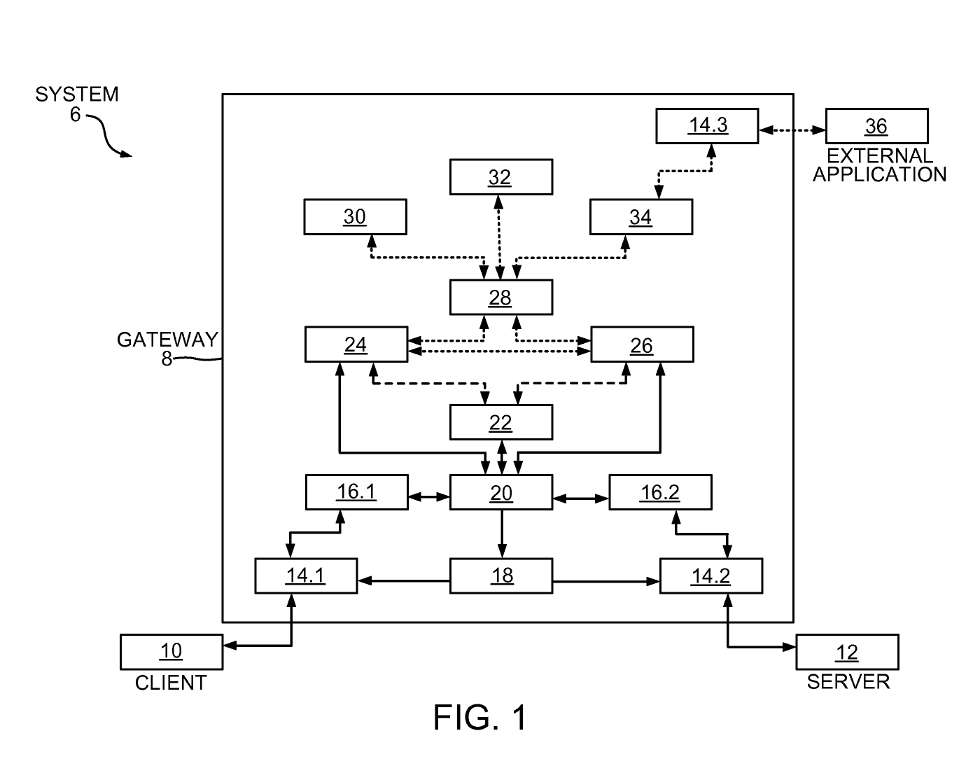

Referring to FIG. 1, a system for processing a secure digital electronic transmission in accordance with the invention is designated generally by reference numeral 6. The system 6 comprises a gateway 8, which is connected between a client 10 and a server 12. The gateway 8 is part of a network and is connected such that network traffic between the client 10 and server 12 is forced to traverse the gateway 8.

The client 10 is connected to the gateway 8 via a network interface 14.1 and the server 12 via a network interface 14.2. The interface 14.1 is connected to a first transmission ID and policy tag module 16.1. The interface 14.2, in turn, is connected to a second transmission ID and policy tag module 16.2. The transmission ID and policy tag modules 16.1 and 16.2 provide an ID for each transmission when the transmission is first received and apply a tag for each transmission indicating whether content of the transmission is to be decrypted. Subsequently, when further traffic of the transmission is received, the transmission ID and policy tag modules 16.1 and 16.2 recognize the transmission, identify its ID and then apply the policy according to the associated tag. It will be appreciated that the transmission ID and policy tag module 16.1 attends to transmissions coming from the client 10, and the transmission ID and policy tag module 16.2 attends to transmissions coming from the server 12.

The gateway 8 has a unit 20 that detects if a transmission is secure and, if so, whether content thereof needs to be decrypted. The unit 20 then supplies the transmission ID and policy tag modules 16.1 and 16.2 with the appropriate policy for the relevant tag. A bypass component 18 is provided to pass transmissions directly between the interfaces 14.1 and 14.2 without having to route through the other components referred to below.

A decrypting information obtaining means for obtaining information required to decrypt the encrypted content and to re-encrypt content is provided in the form of a key agreement component 22. The key agreement component 22 ensures that the gateway 8 has the required information to enable transmissions received from the client 10 and the server 12 to be decrypted and re-encrypted as will be explained below.

The gateway 8 also has “crypting” components 24 and 26. Each crypting component 24, 26 is able to decrypt and re-encrypt material. The gateway 8 further has a deploying and receiving module 28, a processor 30, a store 32 and a forwarding module 34. The forwarding module 34 is connected to a further interface 14.3, whereby the gateway communicates with an external application 36.

In use, the client 10 establishes a secure communication session with the server 12 using an SSL or TLS protocol as a security layer with a TCP transport layer. A first flow results between the client 10 and the server 12. Packets belonging to this first flow enter the gateway via the network interface 14.1. The unit 20 detects that an encrypted, secure transmission has been received. It then determines a decryption policy, i.e., whether decryption is required and to which further entity the plain text resulting from the decryption needs to be sent, using the criteria and policies discussed above. This decryption policy is then tagged with the ID of the transmission by the transmission ID and policy tag module 16.1. If content of the transmission is to be decrypted, the appropriate decrypting information is acquired from the client 10 and the server 12. The relevant content is then decrypted by the crypting component 24.

As indicated above, the key agreement component 22 acquires the necessary information to decrypt the transmission and supplies this information to the crypt component 24. As discussed earlier, this information may include the encryption algorithm negotiated between the client 10 and the server 12, a session key and random obfuscator and/or seed information. The key agreement component 22 acts as a server from the perspective of the client 10 and as the client with respect to the server 12.

Once the key agreement process has been completed, packets belonging to the transmission are sent to the crypting component 24. The transmission from the first client 10 to the server 12 is then decrypted by the crypting component 24 to provide a plain text version of the transmission. The resulting plain text is then sent via the deploying and receiving module 28 and deployed either to the processor 30, the store 32 or the application 36. Further as discussed above, if the plain text is sent to a passive entity such as the store 32, it is sent in read only form, whereas it is in a read-write form if sent to an active entity such as the processor 30 or the application 36. The plain text version may be sent as a stream. As explained above, by packaging the plain text into a new stream, standard, unmodified applications which have been designed to operate on plain text can be utilized.

The processor 30 examines the plain text to detect any illicit material. If no illicit material is detected, then an instruction is sent to the crypting component 26 to re-encrypt the plain text from the first flow, using information supplied by the unit 20, and to deliver it to the server 12 via the interface 14.2.

Similarly, the application 36 processes the plain text supplied by the crypting component 24 and returns modified plain text to the crypting component 26 to be re-encrypted and forwarded to the server 12.

In the event that the unit 20 determines that a transmission does not need to be decrypted, it is routed to the bypass 18 and delivered directly to the target.

With active entities such as the processor 30 and application 36, as discussed above, the system 6 operates in a read-write decrypting and re-encrypting mode. In this mode, in most cases, the flow between the client 10 and the server 12 is terminated at the gateway 8, with the gateway originating a new flow to the server 12. Those skilled in the art will appreciate that traffic from the server 12 to the client 10 is treated similarly, being decrypted by the crypt unit 26 and re-encrypted by the crypt unit 24, where appropriate.

Although certain specific exemplary embodiments are described above in order to illustrate the invention, the invention is not limited to the specific embodiments. Accordingly, various modifications, adaptations, and combinations of various features of the described embodiments can be practiced without departing from the scope of the invention as set forth in the claims.

1-40. (canceled)

41. A method comprising:
intercepting at a gateway a transmission control protocol (TCP) connection between a client and a server, wherein a secure socket layer (SSL) or transport layer security (TSL) session is embedded in the TCP connection;
determining whether contents encrypted in the SSL or TSL session are to be decrypted;
terminating the SSL or TSL session on the gateway;
decrypting the contents of the SSL or TSL session;
processing the decrypted contents to generate processed contents;
encrypting the processed contents to generate re-encrypted contents; and
initiating a second SSL or TSL session between the gateway and the server over the TCP connection, wherein the second SSL or TSL session contains the re-encrypted contents.

42. The method of claim 41, further comprising:
installing a certification authority (CA) certificate on the gateway;
intercepting a server certificate from the server; and
resigning the server certificate using the CA certificate.

43. The method of claim 41, further comprising:
intercepting at the gateway a server certificate from the server;
inserting a session key;
resigning the server certificate; and
transmitting the resigned server certificate to the client as part of the first SSL or TSL session.

44. The method of claim 41, further comprising:
installing a copy of a server private key on the gateway; and
using the server private key to complete negotiating the first SSL or TSL session, wherein both the first SSL or TSL session and the second SSL or TSL session use the same session key.

45. The method of claim 41, further comprising:
installing a copy of a server private key on the gateway; and
using the server private key to complete negotiating the first SSL or TSL session, wherein the first SSL or TSL session uses a different session key than does the second SSL or TSL session.

46. The method of claim 41, wherein the determining whether the contents are to be decrypted is performed based on decryption indicia taken from the group consisting of: a port of the gateway on which the first flow is received; a port of the server to which the first flow is destined, a TCP source address of the client, a TCP destination address of the server, a field in a server certificate, and a field in a client certificate.

47. The method of claim 41, wherein the gateway is taken from the group consisting of: a router, a switch and a bridge.

48. A method comprising:
intercepting at a gateway a first flow of packets between a client and a server;
intercepting at the gateway a second flow of packets between the server and the client;
determining that contents of the first flow are to be decrypted based on packets of the first flow and of the second flow;
assigning a policy tag to the first flow, wherein the policy tag indicates whether the contents of the first flow are to be decrypted;
decrypting the contents of the first flow;
processing the decrypted contents of the first flow to generate processed contents;
encrypting the processed contents to generate re-encrypted contents; and
originating a second flow between the gateway and the server, wherein the second flow contains the re-encrypted contents.

49. The method of claim 48, further comprising:
installing a certification authority (CA) certificate on the gateway;
intercepting a server certificate in the second flow from the server; and
resigning the server certificate using the CA certificate.

50. The method of claim 48, further comprising:
assigning a second policy tag to the first flow subsequent to when the first flow is first received at the gateway, wherein the second policy tag indicates that the contents of the first flow are not to be decrypted

51. The method of claim 48, further comprising:
determining that the contents of the first flow are to be decrypted based on a TCP source address of the client.

52. The method of claim 48, wherein the first flow forms a transmission control protocol (TCP) connection in which secure socket layer (SSL) traffic is embedded.

53. The method of claim 48, wherein the gateway is taken from the group consisting of: a router, a switch and a bridge.

54. A method comprising:
intercepting at a gateway a first flow of packets between a client and a server, wherein the first flow includes encrypted contents in a first secure socket layer (SSL) session and decryption indicia;
determining that the encrypted contents of the first flow are to be decrypted based on the decryption indicia;
decrypting the encrypted contents of the first flow to generate decrypted contents;
processing the decrypted contents of the first flow to generate processed contents;
encrypting the processed contents to generate re-encrypted contents;
terminating the first SSL session on the gateway; and
originating a second SSL session between the gateway and the server, wherein the second SSL session contains the re-encrypted contents.

55. The method of claim 54, wherein the decryption indicia are taken from the group consisting of: a port of the gateway on which the first flow is received; a port of the server to which the first flow is destined, a TCP source address of the client, a TCP destination address of the server, a field in a server certificate, and a field in a client certificate.

56. The method of claim 54, further comprising:
assigning a first policy tag to the first flow, wherein the first policy tag indicates that the encrypted contents of the first flow are to be decrypted;
determining that the encrypted contents of the first flow are no longer to be decrypted; and
assigning a second policy tag to the first flow after the determining that decrypting is no longer required, wherein the second policy tag indicates that the encrypted contents of the first flow are no longer to be decrypted.

57. The method of claim 54, wherein the processing the decrypted contents searches for illicit activity.

58. The method of claim 54, further comprising:
identifying packets of the first flow received by the gateway subsequent to when the first flow is first received at the gateway.

59. The method of claim 54, wherein the first flow forms a transmission control protocol (TCP) connection in which the first SSL session is embedded.

60. The method of claim 54, further comprising:
installing a certification authority (CA) certificate on the gateway.
